(19) United States
(12) Patent Application Publication
(10) Pub. No.: US 2017/0057705 A1
(43) Pub. Date: Mar. 2, 2017

(54) PERFORABLE CONTAINER CAP

(71) Applicant: Integrity Products, Inc., Grandview, MO (US)

(72) Inventor: Jeffrey Bailey, Grandview, MO (US)

(73) Assignee: Integrity Products, Inc., Grandview, MO (US)

(21) Appl. No.: 15/228,179

(22) Filed: Aug. 4, 2016

Related U.S. Application Data
(63) Continuation-in-part of application No. 14/633,127, filed on Feb. 26, 2015.

(51) Int. Cl. B65D 41/50; B65D 51/24; B29C 45/16; B65D 41/34

(52) U.S. Cl. CPC B65D 41/50; B65D 41/34; B65D 51/245; B29C 45/1676; B29K 2023/065

(57) ABSTRACT

A perforable container cap having a top surface that includes a central aperture covered by a membrane that is thin, relative to the thickness of the rest of the cap structure, and, therefore, relatively easy to pierce or puncture with a sampling tube or needle. Embodiments of the container cap may include a membrane comprising a thin plastic, rubber or foil.

### CROSS REFERENCE TO RELATED APPLICATION

This application claims the benefit of, and is a continuation-in-part of, the prior filed, co-pending application Ser. No. 14/633,127, filed on Feb. 26, 2015, which is a continuation in part of application Ser. No. 12/697,094, filed on Jan. 29, 2010, which issued on Apr. 7, 2015 as U.S. Pat. No. 8,998,012, and which claimed priority from provisional patent application No. 61/148,294, filed on Jan. 29, 2009.

### BACKGROUND OF THE INVENTION

Field of the Invention

The present invention relates to a container cap that is attached to the open end of a container to form a liquid-tight seal with the container. The container cap includes a generally centrally disposed membrane portion that may be pierced and perforated by a needle or other sampling element. In some embodiments, the membrane will reseal after the needle is withdrawn. In some embodiments, the membrane comprises a thin layer of foil. The cap may include a distinctive color to alert users that the cap is perforable. Certain embodiments of a container cap according to the present invention include a container cap locking mechanism having features on a container cap, and on an associated container body, that interlock with one another when the cap is fully tightened to provide physical and visual indication that the cap is fully closed and optimally sealed to the container.

Description of the Related Art

Features and devices for locking container caps onto container bodies typically are hidden between the wall of the cap and/or the container neck and often comprise multiple pieces that must be assembled prior to use. Hidden cap locking features typically are used to (Docket 585.008) secure the cap to the container and to prevent the container from inadvertently opening. They do not typically provide a visual indicator to alert a user when the cap has been properly secured to the container body. In particular, a threaded cap must be appropriated threaded onto an associated container body in order for the inner surface of the cap to completely seal against the top surface of the container body neck. Over-tightening can result in deformation of cap and body threads and can also cause the cap or body itself to deform, thereby breaking the seal therebetween.

It is often advantageous for container caps to be paired with a pierceable element, such as a septum, so that the contents of the container may be withdrawn and sampled via syringe or autosampler needle, pipette tube, or other similar, rigid, tubular, sampling element. Container caps in the prior art typically comprise a rigid plastic cap having a large central aperture. A rubber septum is fitted into the bottom of the cap to cover the aperture so that when the cap is attached (typically threaded) onto the top of a container, the top edge of the container seals against the septum around the circumference of the container top edge. Because the septum is generally relatively thick, i.e. thicker than the main body of the cap adjacent to and surrounding the aperture, it must be pierced with a needle sufficiently robust to pierce the septum without bending or breaking. Additionally, due to the thickness of a rubber septum, and the relatively large diameter (and increased friction) of a needle of sufficient strength to pierce it, considerable force must typically be applied to the needle to force it through the septum.

What is needed, therefore, is a container cap locking mechanism that not only locks the cap onto the container when in sufficient sealed engagement, but also provides visual indication of the lock to the user. In addition, there is a need for a cap manufactured with a perforable area integral to the body of the cap, rather than manufactured separately for later assembly prior to use.

### SUMMARY OF THE INVENTION

An embodiment of a perforable container cap may include a cap having a top, perforable wall and an internally-threaded, annular flange formed integrally with the perforable wall. The annular flange extends downward from the perforable wall to enclose a cavity open at a bottom end of the cap for receiving a container.

A further embodiment of a perforable container cap includes a top wall with an annular flange formed integrally with the top wall and extending downwardly from the top wall to enclose a cavity open at a bottom end of the cap. The top wall and annular flange are molded to form a single piece, and the top wall includes a generally centrally disposed aperture covered by a thin, pierceable membrane. The annular flange includes internal threads to threadably engage the external threads of an associated container.

In some embodiments, the membrane comprises a thin sheet of polymer material, such as polyethylene. In some embodiments, the membrane comprises a thin sheet of metal foil that is heat sealed to the attachment surface portion of the cap surrounding and adjacent the central aperture. The foil membrane includes a thin, metal foil layer and a thin, thermoplastic layer bonded to the foil layer. To attach and seal the foil membrane to the cap, the thermoplastic layer is placed over the central aperture to contact the attachment surface and a heat source is applied to the foil layer to heat the foil layer and thereby transmit heat across the foil layer to the thermoplastic layer to melt it to the attachment surface of the cap. In such an embodiment, the cap preferably also comprises a thermoplastic having the same or similar properties as that of the thermoplastic layer of the foil membrane. For example, if the thermoplastic layer of the foil membrane comprises polyethylene, the cap will preferably also comprise polyethylene.

A method for producing an integral, perforable container cap may include the steps of providing a cap having a top wall or surface that includes a substantially central aperture. The cap has an internally threaded annular flange formed integrally (from the same piece of plastic or similar or equivalent material) with the top wall and extending downwardly from the top wall to enclose a cavity. The annular flange surrounds the cavity which is substantially closed at the top by the top wall, but which is open at the bottom end of the cap to threadably receive a container. A thin foil membrane, that includes a thermoplastic layer bonded to a foil layer, is provided and positioned over the central aperture so that the thermoplastic layer extends across the margins of the aperture to contact the attachment surface of the top surface of the top wall of the cap. Essentially, the foil membrane is oversized relative to the aperture so that it may fully overlie and cover the aperture, and attach to the portion of the top wall of the cap which surrounds the aperture (i.e. the attachment surface). After positioning the foil membrane across the aperture as-described, heat is applied to the foil layer overlying the attachment surface to melt the underlying thermoplastic layer of the membrane, and to also melt at least a top layer or portion of the further underlying attachment surface, to fuse the thermoplastic layer of the membrane to the underlying attachment surface. In this manner, the foil membrane may be attached, integrated with, and sealed onto the cap to span across the aperture and to create a liquid-impervious seal across the aperture.

In some embodiments of this cap, the membrane is attached to or integrated into the top wall by in-mold labeling. A method for producing an integral, perforable container cap may include the steps of (a) positioning a thin membrane within a mold so that the membrane extends across the margins of an aperture to be molded in the top wall of a container cap, and (b) injecting thermoplastic material into the mold to form the cap and to adhere or fuse to the membrane. In some embodiments of the method and of the cap, the membrane comprises a thermoplastic material selected to melt sufficiently during molding to fuse with the thermoplastic material of the cap body. In some embodiments of the method and of the cap, the membrane comprises a metal foil.

In other embodiments of the cap, the cap has a top wall and an annular flange formed integrally with the top wall and extending downwardly from the top wall to enclose a cavity open at a bottom end of the cap. The top wall and annular flange are molded to form a single piece. The top wall includes a central aperture, a mounting flange projecting inwardly from the top wall to surround and define the central aperture, and a membrane filling the central aperture and enveloping the mounting flange to secure the membrane within the mounting flange. The membrane itself comprises a relatively soft yet resilient material (such as a plastic or rubber) pierceable by a sharp object, such as a sampling needle, which substantially reseals when the object is withdrawn from the membrane.

An embodiment of a container cap locking mechanism and sealing alignment indicator may include the following features. A threaded cap includes an annular flange or wall having a downward pointing barb and adjacent downward pointing stop, both at the lower edge of the flange. The container body sidewall includes an outwardly extending block having a V-notch sized to receive the barb. Upon sufficient rotation of the threaded cap onto the threaded container neck, the barb is received into the notch and rotation is halted by the stop abutting a side of the block, thus indicating that the closure has achieved maximum desired rotation and is sealed. The interlocked barb and notch also prevent the cap from loosening inadvertently, as may occur due to air pressure changes and/or vibration during shipping. The stop prevents the cap from being over-tightened as the cap is threaded upon the container body.

Certain embodiments of the cap may include one or more barbs extending downward from the annular flange. A barb substantially has a V-shape defined by sides converging distal from the annular flange to a point. A stop positioned next to the barb extends downward from the annular flange so that it is proximate to the barb. The barb and stop engage a block extending outwardly or laterally (i.e. in a direction transverse to the longitudinal axis of the container) from a top end of a threaded container body. The block has a front edge and a back edge that converge in a downward direction to form a V-shaped notch sized for receiving the barb. In other words, the notch includes V-shaped sides converging to a nadir, so that as the bottom end of the cap is threaded onto the top end of the container body (to tighten the cap relative to and onto the container body), the barb slides over the block to be received into the notch. The V-shaped sides of the barb thereby meet, adjoin and abut the V-shaped sides of the notch, and the back edge of the block meets, adjoins and abuts against the stop to impede further tightening of the cap relative to the container body.

The locking mechanism disclosed herein aids a specimen collector by providing a physical as well as visual indication that the container lid or cap has been tightened to an optimal position for sealing the cap to the container, while avoiding and even preventing excessive torque from being applied to the cap through over tightening, thereby ensuring that the container is properly closed, sealed and ready for transport without leakage.

A further embodiment may include a container cap or closure having an integral sampling member (probe, spoon, spork, spatula, etc.). Preferably, the spoon has tines on the distal end to form a structure similar to one commonly known as a spork (combination spoon and fork). The threaded cap includes an integral stem extending from its inner surface and the spoon is on the distal end of the stem.

Another embodiment of a perforable container cap may include an annular side wall surrounding a cavity closed at a top end by an integral top wall, the top wall being perforable by a relatively thin diameter, elongated, tubular sampling element. In this embodiment, the side wall and top wall are substantially formed from a single molded piece of resilient material, such as a thermoplastic. In some embodiments of the cap, the top wall is of substantially uniform thickness. In some embodiments of the cap, the top wall includes a perforation area of reduced thickness. In some embodiments of the cap, the top wall includes a perforation area comprising material optimized to reseal after perforation. In some embodiments of the cap, the top wall comprises a relatively soft and resilient plastic material. More specifically, in some embodiments of the cap, the top wall comprises a material selected from the group consisting of polyethylene, polypropylene, high density polyethylene, linear low density polyethylene, butyl rubber, silicon rubber, urethane and thermoplastic elastomer. In some embodiments of the cap, the top wall comprises a primary layer of polyethylene and also a secondary layer comprising material selected from the group consisting of thermoplastic elastomer, urethane, silicon or butyl rubber, with one of the layers disposed over the other of the layers so that the layers are pierced concurrently or consecutively by a sampling element.

Certain embodiments of a container cap according to the present invention comprise a relatively soft and resilient plastic material so that the upper, perforable wall (top surface) of the cap may be readily pierced by a sampling element such as a sampling needle. Due to the resilience of the plastic material, the puncture hole or perforation substantially reseals after the sampling element is withdrawn.

Other advantages of the invention will become apparent from the following description taken in connection with the accompanying drawings, wherein is set forth by way of illustration and example several embodiments of the present invention.

### BRIEF DESCRIPTION OF THE DRAWINGS

FIG. 1 is a front elevation of a container cap threadably attached to a container body and showing the locking features of the cap intermeshed with the locking features of the body.

FIG. 2 is a partial, enlarged view of a portion of a container, including a view of a locking mechanism of the present invention.

FIG. 3 is a perspective view of a container body.

FIG. 4 is a front elevation of a container body.

FIG. 5 is a side elevation of a container body.

FIG. 6 is a sectional view of a container body taken along line 6-6 in FIG. 4.

FIG. 7 is a front perspective view of a container body.

FIG. 8 is a bottom perspective view of a container body.

FIG. 9 is a top perspective view of a container body.

FIG. 10 is a top plan view of a container body showing the interior of the container.

FIG. 11 is a top plan view of a container cap.

FIG. 12 is a perspective view of an alternative embodiment of a container cap including a tined spoon projecting from the bottom surface of the cap.

FIG. 13 is a side elevation of the cap of FIG. 12.

FIG. 14 is an enlarged view of the locking mechanism shown in FIG. 13.

FIG. 15 is a side elevation of the cap with the spoon pointing upward and the top of the cap pointing downward.

FIG. 16 is a section of the cap of FIG. 15 taken in the plane of line 16-16.

FIG. 17 is a perspective view of a cap with two barb and stop assemblies located on the annular flange in diametrical opposition to each other.

FIG. 18 is a diagram not drawn to scale illustrating the function of the locking mechanism relative to the rotation and sealing of the inner surface of a cap to the upper end of a container body.

FIG. 19 is a diagram not drawn to scale illustrating the function of the locking mechanism relative to the rotation and sealing of the inner surface of a cap to the upper end of a container body.

FIG. 20 is a diagram not drawn to scale illustrating the effect of the locking mechanism of the present invention on achieving and retaining an optimal cap and container seal.

FIG. 21 is a cross sectional cut-away view of a perforable cap according to alternative embodiments of the invention.

FIG. 22 is a cross sectional cut-away view of a perforable cap according to alternative embodiments of the invention including a perforable area of decreased thickness.

FIG. 23 is a cross sectional diagram of a perforable cap according to alternative embodiments of the invention showing a sampling element about to pierce and perforate the perforable wall.

FIG. 24 is a cross sectional diagram of the perforable cap of FIG. 23 showing the perforable wall completely perforated by the sampling element.

FIG. 25 is a cross sectional diagram of the perforable cap of FIG. 23 showing the perforable wall substantially resealed after withdrawal of the sampling element from the perforable wall.

FIG. 26 is a top perspective view of a perforable cap according to alternative embodiments of the invention showing a perforable area in phantom lines.

FIG. 27 is a top perspective view of an alternative embodiment of a cap.

FIG. 28 is a bottom perspective view of an alternative embodiment of a cap.

FIG. 29 is a cross sectional diagram of a cap showing a perforable membrane disposed across the top surface of the cap to seal a central aperture.

FIG. 30 is a cross sectional diagram of a cap showing a perforable membrane disposed across a portion of the top surface of the cap to seal a central aperture.

FIG. 31 is a cross sectional diagram of a cap showing a perforable membrane disposed across a portion of the bottom surface of the cap to seal a central aperture.

FIG. 32 is a cross sectional diagram of a cap showing a perforable foil membrane disposed across a portion of the bottom surface of the cap to seal a central aperture

FIG. 33 is a cross sectional diagram of a cap showing an injection-molded perforable membrane disposed across and filling the central aperture to seal the central aperture

FIG. 34 is a top perspective view of the cap shown in FIG. 33.

### DETAILED DESCRIPTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

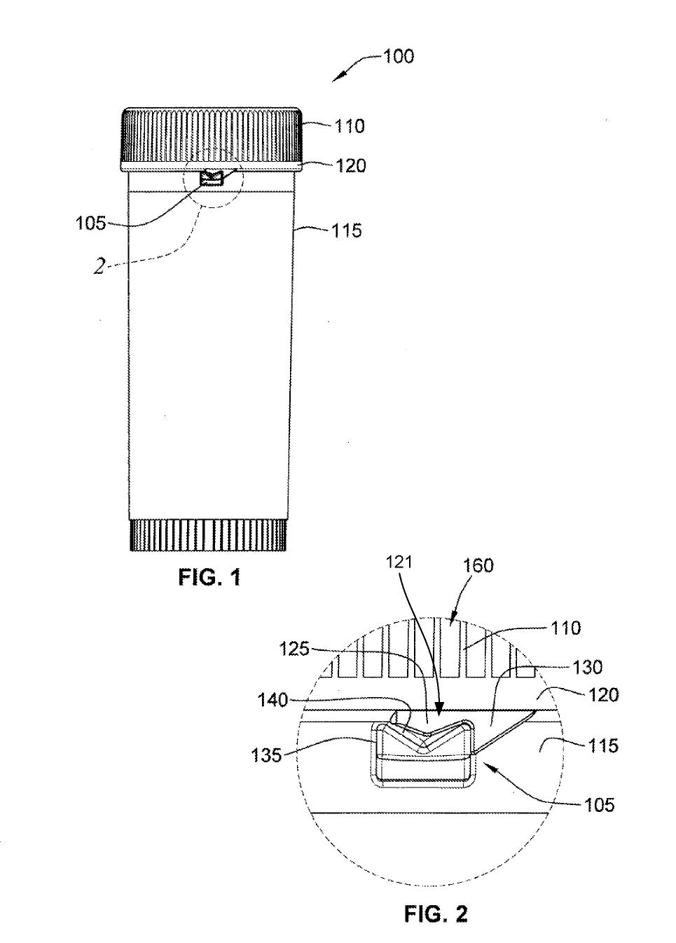

Referring now to the drawings, FIGS. 1 and 2 illustrate a container 100 including an embodiment of the container cap locking mechanism 105. A container cap 110 is threadably attached to a vial or other container body 115 by tightening the cap 110 onto the body 115 until the cooperating elements of the locking mechanism on the cap 110 and on the body 115 align and lock together. The container cap locking mechanism 105 also serves as a sealing alignment indicator and may include the following features. The cap 110 is threaded and includes an annular flange 120 having an upper locking element 121 comprising a downward pointing barb 125 and adjacent downward pointing stop 130 both at the lower edge of the flange 120. The container body 115 sidewall includes a lower locking element comprising an outwardly extending block 135 having a V-shaped notch 140 sized to receive the barb 125. As shown in FIGS. 1, 2, and 18-20, the barb 125 and notch 140 are substantially coplanar when engaged with one another and both exhibit a V-shape when viewed at a front elevation. Upon sufficient rotation of the threaded cap 110 onto the threads 142 of the container threaded neck 145, the barb 125 is received in the notch 140 and rotation is halted by the stop 130 abutting a side of the block 135, thus indicating that the cap 110 has achieved maximum desired rotation and is sealed against the body 115.

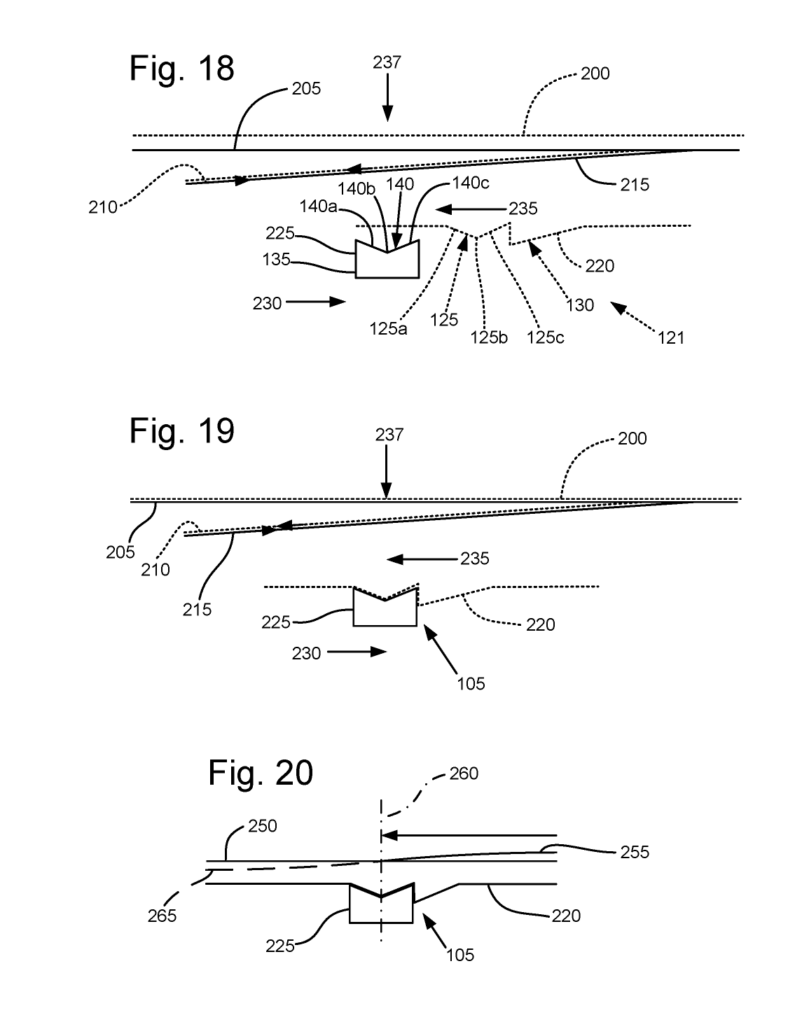

FIG. 1 is a perspective view of a container cap 110 fully screwed or threaded upon a container body 115 and showing the barb 125 and stop 130 of the cap 110 intermeshed or interlocked with the block 135 projecting from the body 115. FIG. 2 is a partial, enlarged view of a container 100 and associated container cap locking mechanism 105. The barb 125 is more clearly shown held within the V-notch 140 of the block 135 and the stop 130 is shown abutting the right side of the block 135 as will occur when the locking mechanism is configured for a cap 110 that is threaded clockwise (as viewed looking down upon the top of the cap 110) onto a container body 115. As shown in FIGS. 1, 2, 19 and 20, the barb 125 and notch 140 are shaped to have cooperating, complimentary, mating surfaces so that when the barb 125 is seated within the notch 140 such surfaces abut to hold the barb 125 at a fixed position within the notch 140 indicating full and optimal closure of the cap 110. As shown mostly clearly in FIGS. 2, 14 and 18-20, the barb 125 includes forward and rear sides that taper and converge to a point, thereby defining the substantial V-shape of the barb 125. More particularly, barb forward side 125a tapers downward and rearward to terminate at the lower margin thereof (and of the barb 125 itself) at the point 125b. Barb rear side 125c tapers downward and forward to also terminate at a lower margin thereof at the point 125b. The notch 140 includes a notch forward side 140a and a notch rear side 140c that are substantially parallel to complimentary, adjacent sides of the barb 125 when the barb is seated within the notch 140. The notch forward side 140a tapers downward and rearward to the nadir 140b or lowest portion of the notch 140. Notch rear side 140c tapers downward and forward to meet notch forward side 140a at nadir 140b, which is defined by the vertex of sides 140a and 140c. In use, as the cap 110 is tightened upon the container body 115, the point 125b rides or slides across the top margin 140d of the notch rear side 140c and then descends into the notch 140 until the point 125b rests at the nadir 140b (see FIGS. 18-20). When the point 125b is at the nadir 140b, the barb forward side 125a lies against the notch forward side 14a, the barb rear side 125c lies against the notch rear side 140c, and the barb 125 is fully engaged with the notch 140. Concomitantly, the stop 130 abuts the right rear edge 135a of the block 135 thereby halting the barb 125 from further forward movement out of the notch 140.

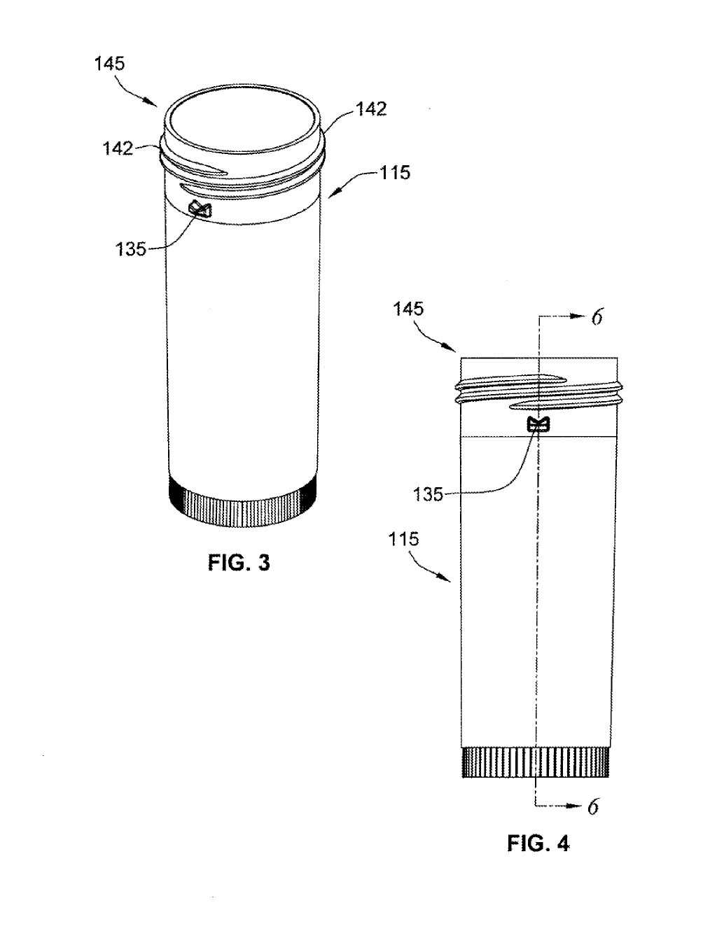

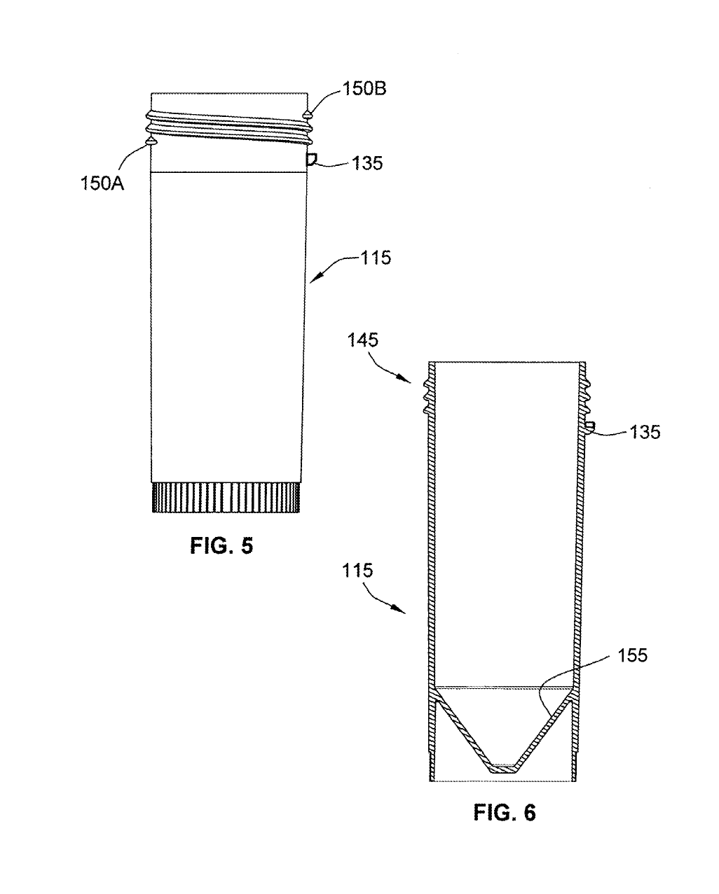

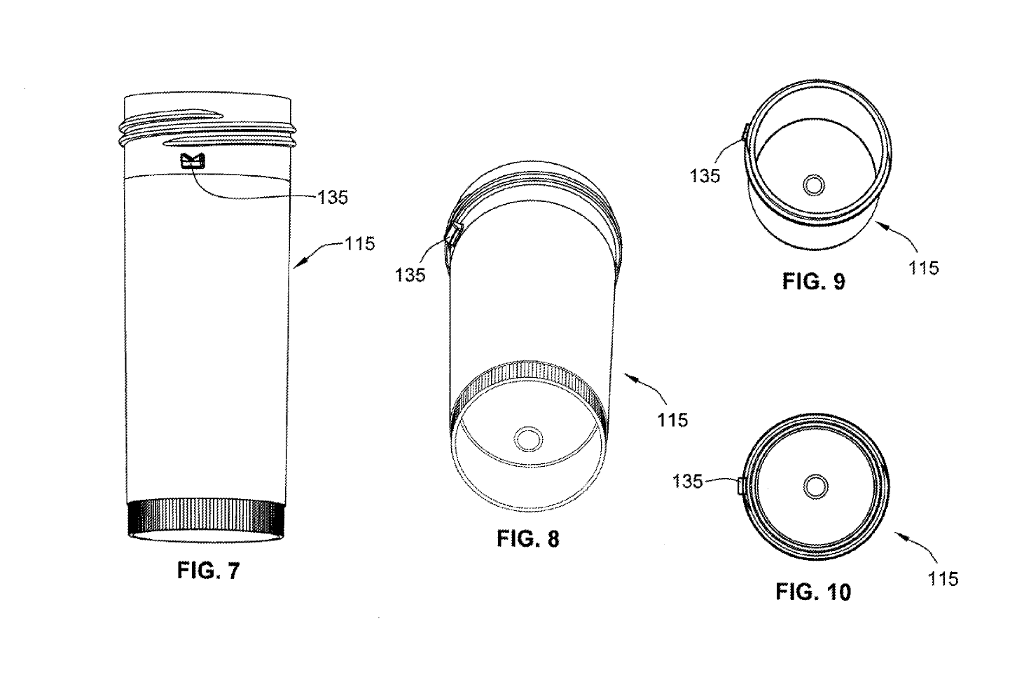

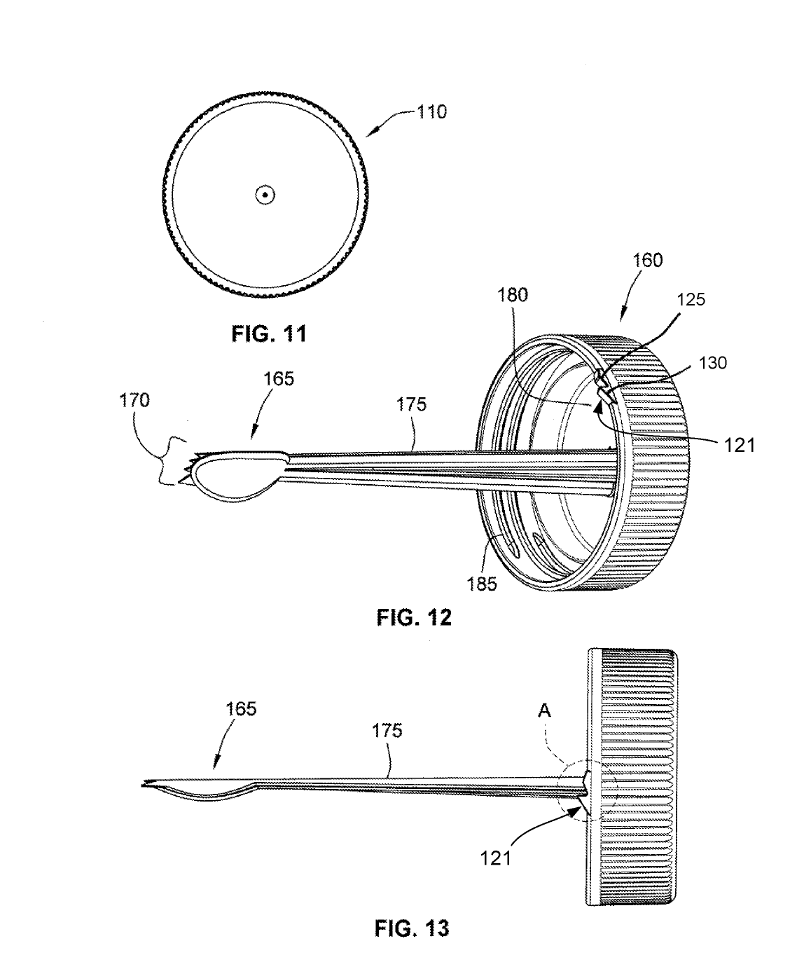

FIGS. 3, 4 and 5 show perspective, front elevation, and side elevation views of a container body 115, respectively. FIG. 6 shows a cross sectional view of a container body 115 or vial having a conical bottom surface 155. FIGS. 7 through 10 show various additional views of a container body 115. FIG. 11 provides a view of the top surface of a container cap 110. As shown most clearly in FIGS. 5 and 9, a container body 115 may include two or more thread starts 150A and 150B, typically no more than four. If preferred, a block 135 may be provided at each thread start to allow for more than one closure site.

A further embodiment of a container 100 may include an alternative container cap 160 or closure having an integral sampling member (probe, spoon, spork, spatula, etc.) 165. Preferably, the spoon 165 has a plurality of tines 170 projecting from the distal end of the spoon 165 to form a structure similar to one commonly known as a spork (combination spoon and fork). The threaded cap 160 includes an integral stem 175 extending from its inner surface 180 and the spoon 165 is on the distal end of the stem 175.

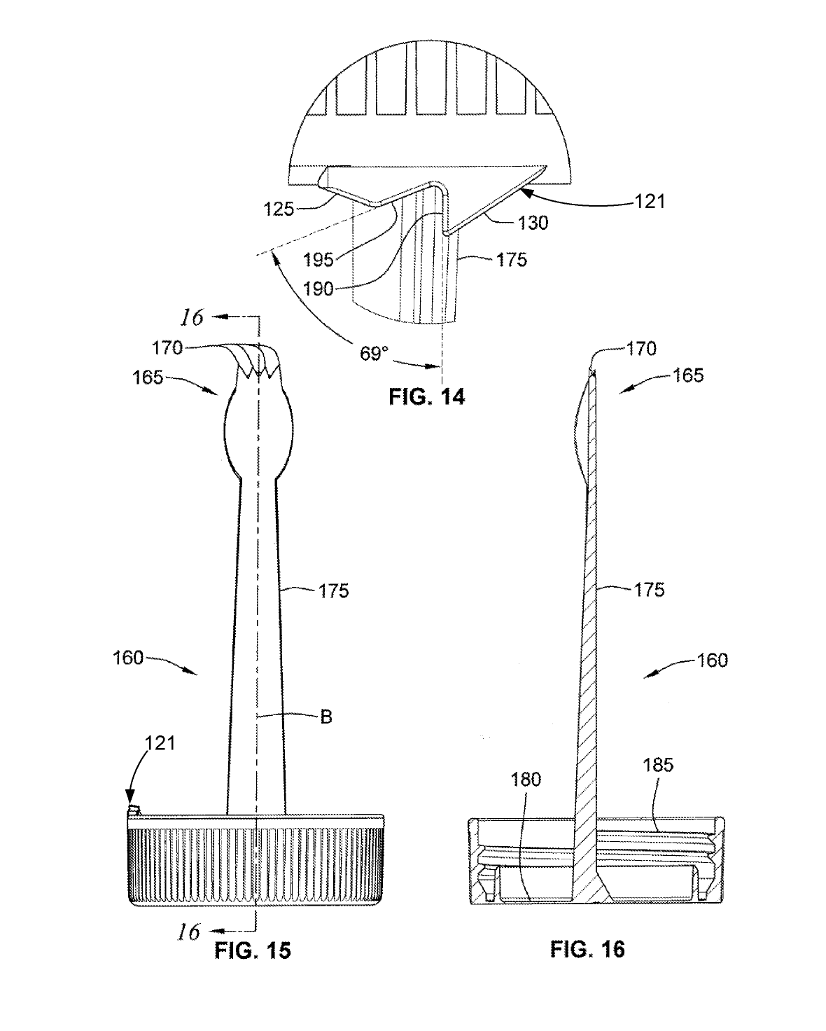

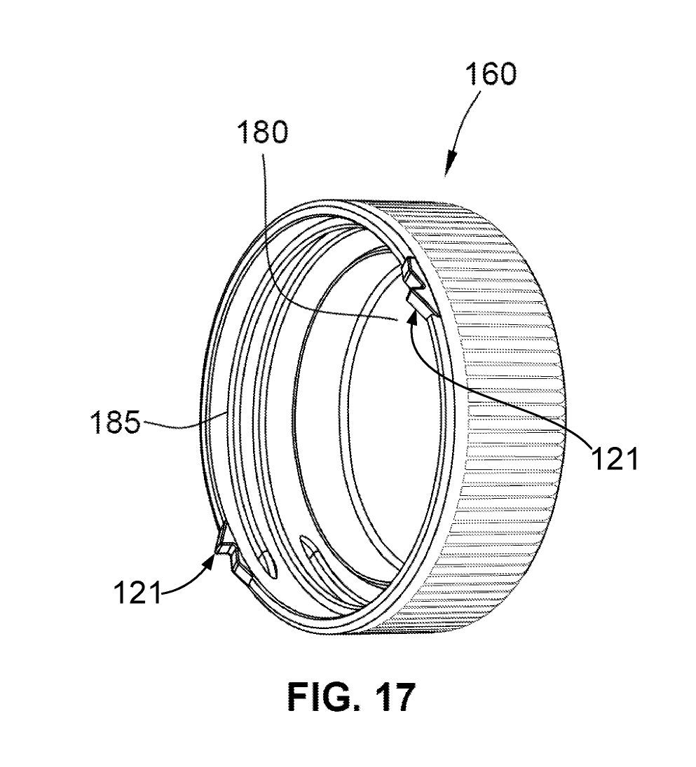

FIGS. 12, 13, 15 and 16 provide various views of the cap 160 including cap threads 185. FIG. 14 is an enlargement of a region defined by circle A in FIG. 13. The embodiment shown in FIG. 14 includes an operable angle of approximately 69° between the surface 190 of the stop 130 that abuts the block 135 and the proximate surface 195 of the barb 125. The surface 190 of the stop 130 is generally parallel to the longitudinal axis (see phantom line B in FIG. 15) of the container and cap 160.

FIGS. 18 and 19 are diagrams not drawn to scale illustrating the function of the locking mechanism 105 relative to the rotation and sealing of the inner surface of a cap 110 to the upper end of a container body 115. Phantom lines in FIGS. 18 and 19 represent structures associated with a cap 110, and solid lines represent structures associated with a container body 115. Phantom line 200 represents the inner surface of a cap 110 adapted to seal against the upper end of a container 115. Solid line 205 represents the surface of the upper end of a container body 115 adapted to seal against the inner surface of a cap 110. Phantom line 210 represents the inclined plane of a cap thread adapted to cooperatively and threadably engage a container body thread. Solid line 215 represents the inclined plane of a container body thread adapted to cooperatively and threadably engage a cap thread. Phantom line 220 represents the barb 125 and stop 130 of a cap 110 and moves in conjunction with lines 200 and 210. Solid shape 225 represents a block 135 attached to a container body 115 and moves in conjunction with lines 205 and 215. As elements 200, 210 and 220 move leftward in accord with cap rotation to tighten upon a container, elements 205, 215 and 225 may be moved rightward or may remain stationary, the effect being that such elements move relative to each other in the directions shown by arrows 230 and 235.

As illustrated through the comparison of FIGS. 18 and 19, as the cap elements move leftward and thread 210 slides downward along thread 215, the cap sealing surface 200 is drawn downward (in the direction of arrow 237) against the container sealing surface 205. Elements 200-225 are calibrated and constructed so that when sealing surfaces 200 and 205 are drawn together optimally to form a seal, barb 125 has moved leftward and downward sufficiently to fully engage with notch 140 and stop 130 abuts the right, rear edge of block 225. Block 225 therefore presents an impediment via its engagement with barb 125 and stop 130 to further leftward movement and tightening of the cap relative to the container body 115, and optimal sealed engagement of the cap 110 to the container is achieved and indicated visually via the disposition of barb 125 within notch 140.

FIG. 20 is a diagram not drawn to scale illustrating the effect of the novel locking mechanism of the present invention on achieving and retaining an optimal cap and container seal. Solid line 250 represents the interface between cap and container sealing surfaces when an optimal seal is achieved therebetween. Solid line 255 represents the relative degree of tightening between the cap 110 and container 115 with the space between lines 250 and 255 indicating the magnitude of the gap therebetween. Phantom line 260 intersects the point on line 255 where line 255 intersects line 250 indicating that optimal tightening of the cap 110 to the container 115 has been achieved and that this is concomitant with full engagement of the barb 125 within the notch 140. Phantom line 265 indicates that if overtightening were to occur, as might be the situation without the present locking mechanism 105 to prevent overtightening, further tightening of the cap 110 upon the container 115 may cause flexion of the cap 110 and/or container 115 structures thereby reducing the quality of the seal by creating or increasing gaps between the cap and container sealing surfaces.

A method of using a locking mechanism 105 of the present invention may include the steps of providing a threaded container body 115 with an open upper end, and providing a cooperatively threaded container cap 110 having a closed upper end and an open bottom end. The cap 110 may have a forward rotative direction of travel when rotated to tighten upon the container body 115 and a rearward rotative direction of travel when rotated to loosen and disengage from the container body 115.

The cap 110 further includes a pointed barb 125 projecting downward from the bottom end and a stop 130 positioned proximate to, and rearward of, the barb 125 and also projecting downward from the bottom end. The container body 115 includes a block 135 projecting outward from the body 115. The block 135 includes a notch 140 in an upper surface thereof, the notch 140 sized to accept and retain the barb 125. Further steps include rotatively engaging the cap 110 with the body 115 by turning the cap 110 in a forward direction to engage cooperative threads on the cap 110 and body 115 with one another, and continuing to turn the cap 110 in a forward direction until the barb 125 is positioned within the notch 140 and the stop 130 is positioned against a rearward side of the block 135, thereby halting rotation of the cap 110 relative to said body 115. Turning the cap 110 until the barb 125 is positioned within the notch 140 assures that the body 115 and the cap 110 are in sealed engagement. Turning the cap 110 until the barb 125 is positioned within the notch 140 also visually indicates that the body 115 and the cap 110 are in sealed engagement.

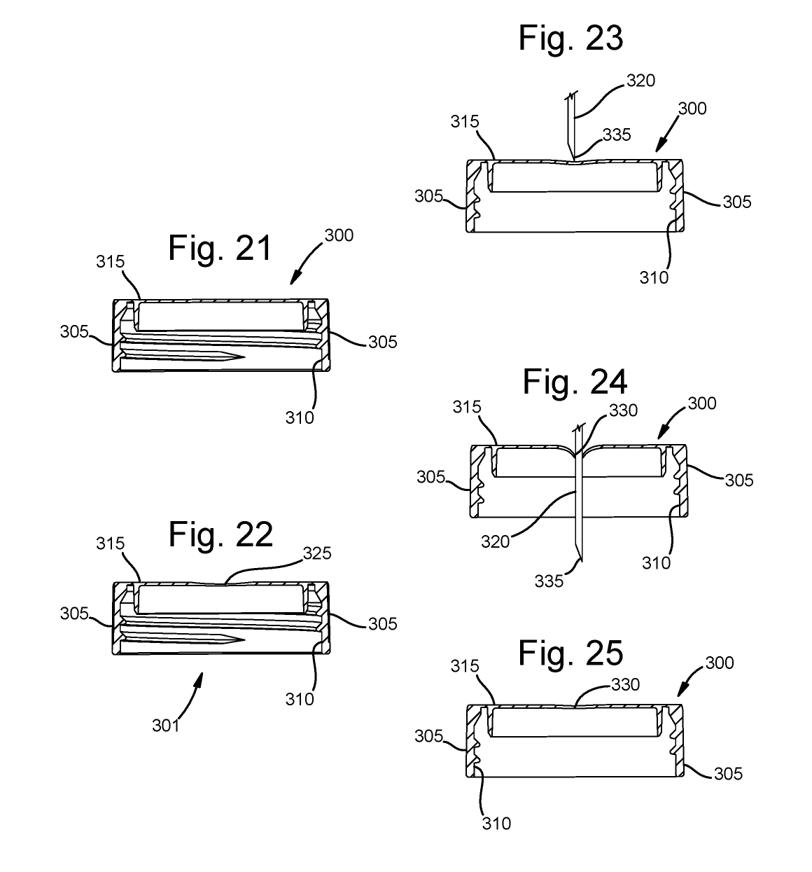

Alternative embodiments of the invention include a perforable container cap 300 (see FIGS. 21 and 23-26) which may include an annular, side flange or wall 305 surrounding a cavity 310 (see FIG. 28) closed at a top end by a top, transverse, perforable wall 315 pierceable or perforable by a relatively thin diameter elongated element such as a hollow needle or other tubular sampling element 320 (see FIGS. 23 and 24) adapted for transferring liquid from a container body 115 enclosed by the cap 300 to the sampling element 320. In preferred embodiments of the invention, a sampling element 320 may be inserted through the perforable wall 315 without the need to previously pierce the perforable wall 315.

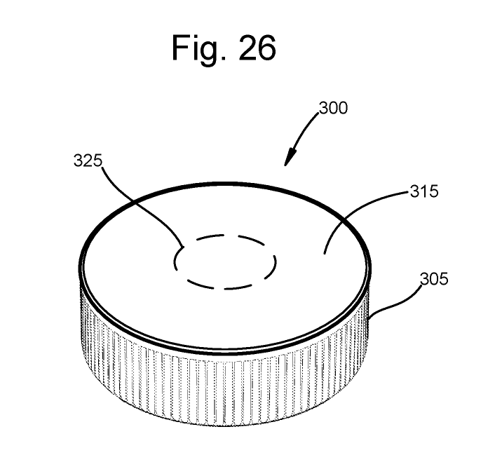

The perforable wall 315 may be of substantially uniform thickness and composition or may include a needle receiving or perforation area 325 (indicated by phantom lines in FIG. 26). The perforation area 325 may be of a composition particularly optimized for resealing after being pierced or perforated, or may be of reduced thickness (see cap 301 illustrated in FIG. 22) relative to the remaining area of the wall 315. In preferred embodiments, no slits are required in the perforable wall 315 to ease or accommodate insertion of the sampling element 320. In such embodiments, the perforable wall 315 comprises a relatively soft and resilient plastic material, such as polyethylene or polypropylene, that may be readily punctured by a sharp object if sufficient force is applied to the object to drive it through the perforable wall 315, and will yet substantially reseal around the puncture site or hole 330 (see FIG. 24) once the object (e.g. sampling element 320) is withdrawn.

Appropriate cap materials include plastics such as high density polyethylene (HDPE) and linear low density polyethylene (LLDPE), including mixtures thereof. A perforable wall 315 comprising such materials tends to stretch around a sampling element 320 when pierced by same and then substantially or generally relaxes or returns to its original configuration or disposition after the sampling element 320 is withdrawn so that the puncture hole 330 substantially or generally reseals (see FIG. 25). In some embodiments, the perforable wall 315 may comprise an elastomer membrane comprising silicon, butyl rubber and/or a thermoplastic elastomer (TPE). In some embodiments, the perforable wall 315 may include two or more layers of perforable material comprising two or more of the following materials: TPE, polyethylene, urethane, silicon or butyl rubber. In some embodiments, the perforable wall 315 comprises a primary layer of polyethylene and also a secondary layer of TPE, urethane, silicon or butyl rubber, one layer disposed over the other so that the layers are pierced concurrently or consecutively by a sampling element 320.

When creating an embodiment of the perforable wall 315 of the cap 300, various factors may be considered or optimized, since they may affect resistance of the cap 300 to perforation. This may affect or determine the selection of material used to form the cap 300 or perforation area 325. These factors may include:

a. the diameter of the needle or other sampling element 320 to be used to pierce or perforate the cap 300;

b. whether the sampling element 320 is provided with a sharpened tip 335 to facilitate piercing the cap 300;

c. the softness, elasticity or malleability of the material (e.g. plastic) used to form the cap 300 or perforation area 325;

d. the thickness of the perforation wall 315 (increased thickness may to tend to increase resistance of the wall 315 to puncture or perforation but may also enhance the ability of the wall 315 to reseal around the puncture hole 330); and

e. the perforation wall 315 diameter.

It should be appreciated that other factors may be considered both when selecting sampling elements 320 and cap 300 dimensions, construction and materials. It may be advantageous for certain embodiments of a cap 300 to be optimized for suitable use with sampling elements 320 such as autosampler needles.

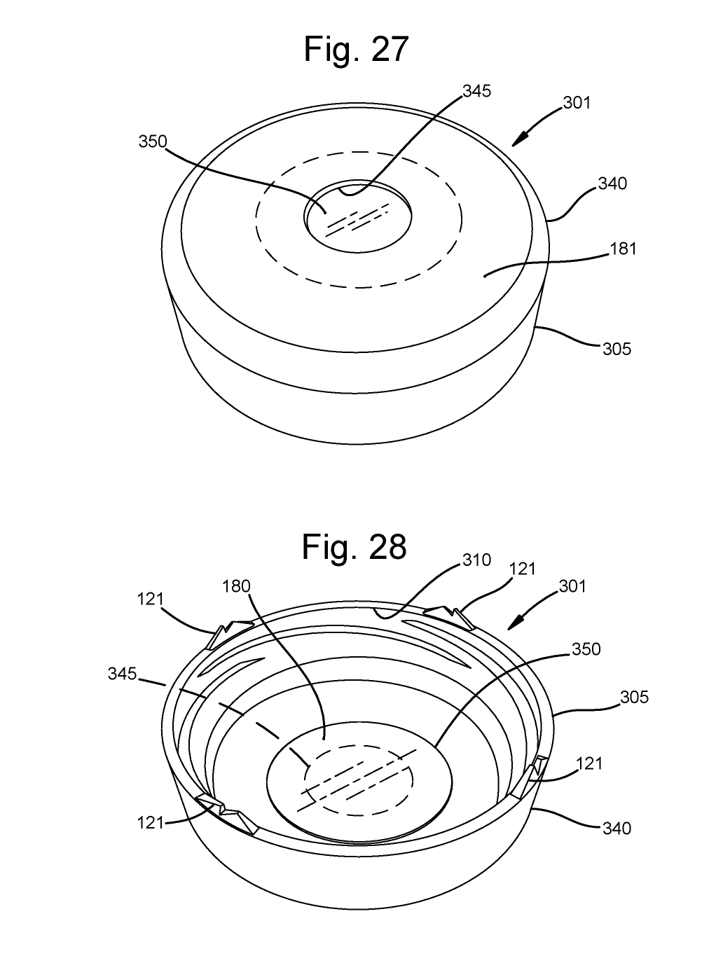

Certain embodiments of a perforable container cap 301 comprise a main cap body 340 manufactured to include a central aperture 345 (see FIGS. 27-31) in the top wall or surface 181 of the cap 301. The central aperture 345 is created either during molding of the cap, as a feature of the cap 301 incorporated into the mold (not shown but conforming as necessary to the contours of the molded elements of the cap), or is die cut or otherwise created after molding of the cap 301 as a secondary operation. The central aperture 345 is covered and sealed using a thin, pierceable membrane 350.

The membrane 350 may be integrated into the structure of the cap 301 via a process known and generally referred to in the art as in-mold labeling. The process includes inserting a label, or other thin, relatively planar item, into an empty mold prior to injection of the molding resin so that the label is adhered to the molded item as it is formed. In correspondence with the present invention, a thermoplastic resin (see examples above) is selected to comprise the cap 301. Prior to injection of the resin into a cap mold (not shown), a membrane 350 is inserted into the mold and appropriately positioned to cover the aperture 345. The cap 301 with integral membrane 350 is then created by injecting melted resin into the mold so that the membrane 350 is integrated into the cap 301 structure and disposed across the aperture 345. If the selected membrane 350 material and cap 301 material comprise similar materials, i.e. both are substantially thermoplastics, the membrane 350 and cap 301 typically melt into one another (plastic weld), where adjoined, thereby substantially forming a single integrated cap 301 structure.

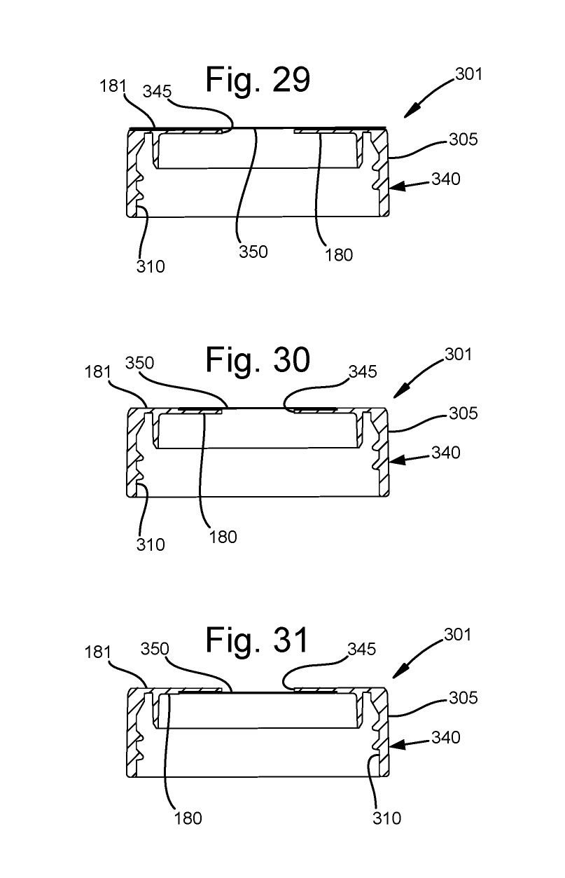

In certain other embodiments of a cap 301, after the main body 340 (including aperture 345) is formed, a thin membrane 350 is disposed across the aperture 345 to seal the aperture 345. The membrane 350 may comprise a thin sheet of polymer material, such as polyethylene. The membrane 350 is then is heated and melted to adhere, fuse or weld to the main body 340. As shown in FIGS. 27, 28 and 31, the membrane 350 may be positioned across the inner, lower surface 180 of the cap 301 proximate the aperture 345 or may be positioned across the outer, top surface 181 of the cap 301 (either partially or completely) as shown in FIGS. 29 and 30. Portions of the lower surface 180 or top surface 181 surrounding the aperture 345 may be recessed (see FIGS. 30 and 31) to receive the membrane 350.

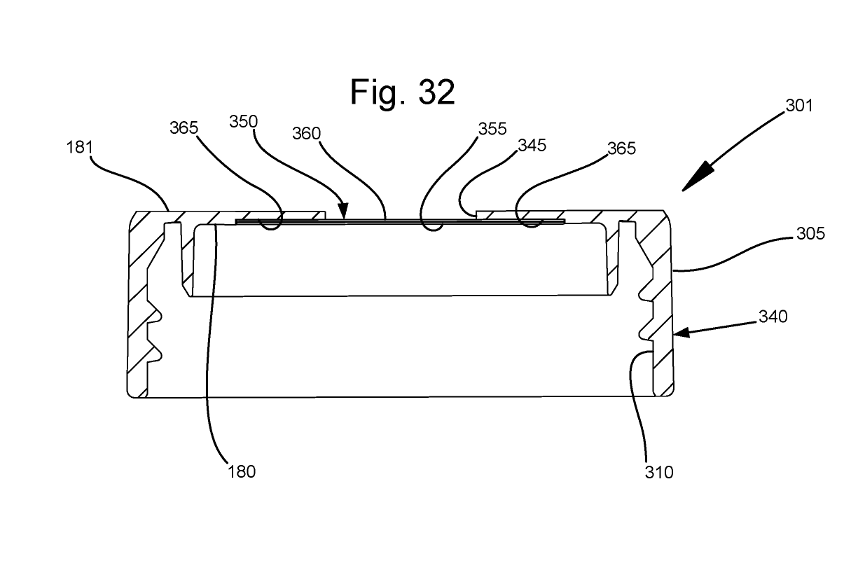

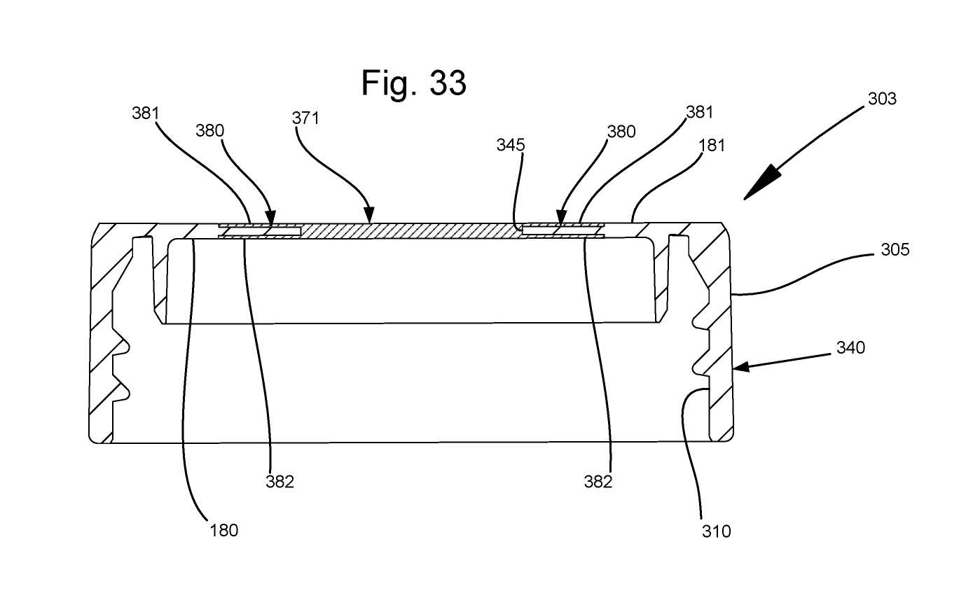

In other embodiments of a cap 301, the membrane 350 comprises a thin sheet of metal foil that is heat sealed to the attachment surface 365 portion of the cap 301 surrounding and adjacent the central aperture 345. The foil membrane 350 includes a thin, metal foil layer 355 and a thin, thermoplastic layer 360 bonded to the foil layer 355, via bonding agent or other means known in the art. FIG. 32 is a cross sectional diagram of such a cap 301 showing the perforable foil membrane 350 disposed across the central aperture 345, and also extending across the attachment surface 365 portion of the bottom surface of the cap 301, to seal the central aperture 345. The foil membrane 350 is attached and sealed to the cap 301, as follows. The foil membrane 350 is placed over the central aperture 345 so that the thermoplastic layer 360 comes into direct contact with the attachment surface 365. The thermoplastic layer 360 is, therefore, proximate to the attachment surface 365 and the foil layer 355 is distal from the attachment surface 365, so that the thermoplastic layer 360 is sandwiched between the attachment surface 365 and the foil layer 355 (see FIG. 32). As shown in FIG. 32, the attachment surface 365 may be recessed to partially or wholly accommodate (e.g. receive and hold) the membrane 350. The attachment surface 365 may be on the lower surface 180 (as shown in FIG. 32) or top surface 181 of the cap 301. In either case, the membrane 350 is mounted therein with the thermoplastic layer 360 proximate the attachment surface 365.

A heat source (not shown but known in the prior art) is applied to the foil layer 355 to heat the foil layer 355 and thereby transmit heat across and through the foil layer 355 to the thermoplastic layer 360 to melt the thermoplastic layer 360 to the attachment surface 365 of the cap 301. The cap 301 should, therefore, preferably also comprise a thermoplastic material having the same or similar properties (such as melting point or temperature) to that of the thermoplastic layer 360 of the foil membrane 350. For example, if the thermoplastic layer 360 comprises polyethylene, the cap 301 will preferably also comprise polyethylene. In certain embodiments, the foil membrane 350 comprises a 33 micron aluminum foil layer 355 and a 25 micron thermoplastic layer 360. In certain embodiments, the thermoplastic layer 360 comprises polyethylene, and the attachment surface 365 comprises polyethylene having a substantially similar melting point. In certain embodiments, the foil membrane 350 has a thickness of between 0.0015 and 0.100 inches. The thickness and resiliency of the foil membrane 350 may be optimized by minimal experimentation to accommodate various sampling elements (e.g. needles, pipette tubes) of various sizes and gauges.

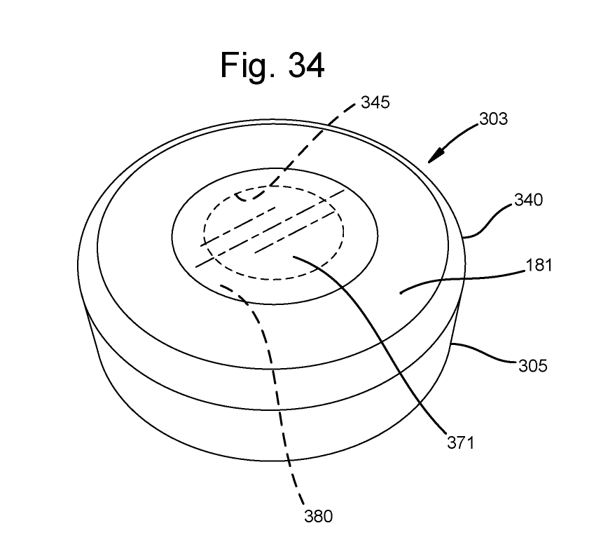

FIG. 33 is a cross sectional diagram of a further alternative embodiment of a cap 303 showing an injection-molded perforable membrane 371 disposed across and filling the central aperture 345 to seal the central aperture 345. FIG. 34 is a top perspective view of the cap 303 shown in FIG. 33. This embodiment of a cap 303 is typically created by first forming the main body 340 of the cap by injection molding or equivalent process. After the main body 340 is formed within the mold, a softer plastic or rubber material (such as butyl or silicone rubber) is injected into the mold to fill the central aperture 345 and form an injection-molded perforable 371 that, in some embodiments, substantially reseals after perforation or piercing during use. As shown in FIG. 33, portions of the top surface 181 and lower surface 180 of the cap 303 surrounding the aperture 345 are recessed to create a narrowed, thin, annular, mounting flange 380. As the material forming the injection-molded perforable membrane 371 is injected into the mold, this material fills the aperture 345 and envelops the mounting flange 380 by filling the recessed areas of the top surface 181 and lower surface 180. As shown in FIG. 33, after the molding process is complete, the injection-molded perforable membrane 371 includes a top flange 381 that overlies the top surface of the mounting flange 380 by filling the top recessed area, and a lower flange 382 that underlies the lower surface of the mounting flange 380 by filling the lower recessed area. In certain embodiments, the injection-molded perforable membrane 371 has a thickness of between 0.005 and 0.090 inches. In certain embodiments, the cap 303 includes one or more upper locking elements 121 (as shown, for example, in FIG. 28 and described above) for locking onto cooperating blocks 135 on a container body 115.

In order for users to readily distinguish between perforable and non-perforable caps, the perforable caps 300 of an embodiment of the present invention may typically comprise a plastic material provided with a distinctive and distinguishing color. Colorant or colored material selected for this purpose should be chemically stable under anticipated operating conditions to avoid leaching and contamination of samples and to avoid degradation of the cap 300 itself. In general, material used to construct a cap 300 should be selected for resistance to common laboratory solvents and sample reagents.

Materials used to form a cap (300 or 301) may include formulations comprising HDPE, LLDPE, a colorant and slip. Slip comprises a material known in the art to reduce friction in threaded caps. An exemplary formulation for the cap body 340 includes 95% HDPE, 3% slip and 2% colorant. LLDPE can be substituted for a portion of the HDPE at a 1:1 ratio. Exemplary formulations for cap 300 having a perforable wall 315 (i.e. without separate membrane) include:

Example 1

| | |
|---|---|
| HDPE | 47.5%-85% |
| LLDPE | 47.5%-10% |
| Slip | 3%-3% |
| Color | 2%-2% |

Example 2

| | |
|---|---|
| HDPE | 65%-85% |
| LLDPE | 30%-10% |
| Slip | 3% |
| Color | 2% |

Color may be provided by selecting from various plastic colorants used in the art to color thermoplastics, including various oxides. Slip agents known in the art may be used, such as amides. If colorant or slip are not used, they should be made up with or replaced by corresponding amounts of HDPE or LLDPE.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is:

1. A method for producing an integral, perforable container cap comprising the steps of:
providing a cap having a top wall that includes a central aperture, an internally threaded annular flange formed integrally with the top wall and extending downwardly from the top wall to enclose a cavity which is open at a bottom end of the cap to threadably receive a container;
providing a thin foil membrane having a thermoplastic layer bonded to a foil layer;
positioning the thin foil membrane over the aperture so that the thermoplastic layer of the membrane extends across the margins of the aperture to contact the attachment surface of the top wall of the cap;
applying heat to the foil overlying the attachment surface to melt the underlying thermoplastic layer, and the further underlying attachment surface, to fuse the thermoplastic layer to the attachment surface, whereby the foil membrane is attached across the aperture to seal the aperture.

2. The method of claim 1, wherein said container cap further comprises:
a barb extending downwardly from said annular flange, said barb substantially having a V-shape defined by sides converging to a point, and
a stop extending downwardly from said annular flange proximate said barb.

3. The method of claim 2, wherein:
said barb and said stop engage a block extending outwardly from a top end of a threaded container body,
said block having a front edge and a back edge and forming a V-shaped notch for receiving said barb,
said notch including V-shaped sides converging to a nadir so that as the bottom end of said cap is threaded onto said top end of said container body to tighten said cap relative to said container body, said barb slides over said block to be received into said notch, said V-shaped sides of said barb thereby abutting said V-shaped sides of said notch, and said back edge of said block abuts against said stop to impede further tightening of said cap relative to said container body.

4. A perforable container cap comprising:
a cap having a top wall, and
an annular flange formed integrally with said top wall and extending downwardly from said top wall to enclose a cavity open at a bottom end of said cap,
said top wall and said annular flange molded to form a single piece, said top wall including a central aperture covered by a thin, pierceable membrane integrated into said top wall by in-mold labeling.

5. The perforable container cap of claim 4, wherein said membrane comprises material optimized to reseal after perforation.

6. The perforable container cap of claim 4, wherein said membrane comprises a relatively soft and resilient plastic material.

7. The perforable container cap of claim 4, wherein said membrane comprises a material selected from the group consisting of metal foil, polyethylene, polypropylene, high density polyethylene, linear low density polyethylene, butyl rubber, silicon rubber, urethane and thermoplastic elastomer.

8. The perforable container cap of claim 4, wherein said membrane comprises a primary layer of polyethylene bonded to said attachment surface of said top wall and a secondary layer comprising material selected from the group consisting of thermoplastic elastomer, urethane, metal foil, silicon or butyl rubber, said secondary layer bonded to said primary layer.

9. The perforable container cap of claim 4, further comprising:
a barb extending downwardly from said annular flange, said barb substantially having a V-shape defined by sides converging to a point,
a stop extending downwardly from said annular flange proximate said barb,
a threaded container body having an open top end and a closed bottom end, and
a block extending outwardly from said top end of said container body, said block having a front edge and a back edge and forming a V-shaped notch for receiving said barb, said notch including V-shaped sides converging to a nadir,
wherein as the bottom end of said cap is threaded onto said top end of said container body to tighten said cap relative to said container body, said barb slides over said block to be received into said notch, said V-shaped sides of said barb abutting said V-shaped sides of said notch, and said back edge of said block abuts against said stop to impede further tightening of said cap relative to said container body.

10. A method for producing an integral, perforable container cap comprising the steps of:
positioning a thin membrane within a mold so that the membrane extends across the margins of an aperture to be molded in the top wall of a container cap;
injecting thermoplastic material into the mold to form the cap and to adhere or fuse to the membrane.

11. The method of claim 10 wherein said membrane comprises a thermoplastic material selected to melt sufficiently during molding to fuse with the thermoplastic material of the cap body.

12. A perforable container cap comprising:
a cap having a top wall,
an annular flange formed integrally with said top wall and extending downwardly from said top wall to enclose a cavity open at a bottom end of said cap,
said top wall and said annular flange molded to form a single piece, said top wall including a central aperture,
a mounting flange projecting from said top wall to surround and define said central aperture,
a membrane filling said central aperture and enveloping said mounting flange to secure said membrane within said mounting flange,
said membrane comprising a resilient material pierceable by a sharp object which substantially reseals when said object is withdrawn from said membrane,
a barb extending downwardly from said annular flange, said barb substantially having a V-shape defined by sides converging to a point,
a stop extending downwardly from said annular flange proximate said barb,
a threaded container body having an open top end and a closed bottom end, and
a block extending outwardly from said top end of said container body, said block having a front edge and a back edge and forming a V-shaped notch for receiving said barb, said notch including V-shaped sides converging to a nadir,
wherein as the bottom end of said cap is threaded onto said top end of said container body to tighten said cap relative to said container body, said barb slides over said block to be received into said notch, said V-shaped sides of said barb abutting said V-shaped sides of said notch, and said back edge of said block abuts against said stop to impede further tightening of said cap relative to said container body.

13. The container cap of claim 12 wherein said membrane comprises a thermoplastic material.

14. The container cap of claim 12 wherein said membrane comprises a butyl rubber.

15. The container cap of claim 12 wherein said membrane is formed within said aperture via injection molding.
